(19) United States
(12) Patent Application Publication
(10) Pub. No.: US 2009/0225195 A1
(43) Pub. Date: Sep. 10, 2009

(54) METHOD AND APPARATUS FOR PROCESSING IMAGES IN CAMERA

(76) Inventors: Sungha Seo, Pyeongtaek-si (KR); Namkyu Ahn, Pyeongtaek-si (KR); Chol Min, Pyeongtaek-si (KR)

Correspondence Address: BIRCH STEWART KOLASCH & BIRCH, PO BOX 747, FALLS CHURCH, VA, 22040-0747, US

(21) Appl. No.: 12/400,414

(22) Filed: Mar. 9, 2009

(30) Foreign Application Priority Data
Mar. 10, 2008 (KR) 10-2008-0022194

(51) Int. Cl. H04N 9/68; H04N 5/228

(52) U.S. Cl. 348/234; 348/222.1; 348/E05.031; 348/E09.053

(57) ABSTRACT

A method and an apparatus for processing images in a camera are provided. Even lines and odd lines of a photographing device are respectively read at different points of time to obtain even line data and odd line data and motion estimation is performed on one of the even line data and the odd line data on the basis of an image related to the other of the even line data and the odd line data right of an immediately prior point in time to the one of the even line data and the odd line data to generate a motion-compensated image. Accordingly, a quantity of electric charges charged in the photographing device comes to be increased such that a bright image of an object can be taken and a motion of an image comes to be accurately estimated such that a more distinct moving image can be obtained.

### BACKGROUND OF THE INVENTION

1. Field of the Invention

The present invention relates to a method and an apparatus for processing images in a camera, and more particularly, to a method and an apparatus for compensating for low illumination in a video camera.

2. Discussion of the Related Art

A camera that captures still images or moving images includes a photographing device having a plurality of cells, such as a charge coupled device (CCD) or complementary metal oxide semiconductor (CMOS) image sensor, and converts light reflected from an object and input to the cells through a lens into electric signals.

The camera may control such that the appropriate quantity of light is input to the cells of the photographing device or control a photo-electric conversion gain through the photographing device or an amplifying device following the photographing device in order to distinguish an object from a background or noise.

When the camera photographs a high-luminance object, for instance, the camera can reduce the degree to which an iris is opened to decrease the quantity of light input to the photographing device, control a shutter speed of the photographing device to be short to decrease the quantity of electric charges charged in pixels of the photographing device or reduce the gain of an amplifier for amplifying an output signal of the photographing device.

On the contrary, when the camera photographs a low-luminance object, the camera can increase the degree to which the iris is opened to increase the quantity of light input to the photographing device, control the shutter speed of the photographing device to be long to increase the quantity of electric charges charged in the pixels of the photographing device or increase the gain of the amplifier for amplifying the output signal of the photographing device.

Accordingly, the camera can automatically control the degree to which the iris is opened, the shutter speed of the photographing device and the gain of the amplifier to photograph an object in an appropriate luminance.

When the camera is set in a low-illumination photographing mode for photographing a low-luminance object, the camera controls the shutter speed to be long to increase the quantity of electric charges charged in the pixels of the photographing device, and thus the luminance level of the object increases and a bright image of the object can be captured. In this case, however, an exposure time increases and thus the object in still images of a captured video is not still and only a motion of the object is displayed. This brings about a problem that the object cannot be correctly confirmed.

### SUMMARY OF THE INVENTION

It is an object of the present invention to provide a method for processing images in a camera, which takes a bright and distinct image of an object to correctly recognize the object even in a place with a low luminance.

An image processing method in a camera according to an aspect of the present invention comprises respectively reading even lines and odd lines of a photographing device of the camera at different points of time to obtain corresponding even line data and odd line data thereof; and performing motion estimation on one of the even line data and the odd line data on the basis of an image related to the other of the even line data and the odd line data of an immediately prior point of time to the one of the even line data and the odd line data, to generate a motion-compensated image.

An image processing apparatus in a camera according to another aspect of the present invention comprises an image data reading unit configured to separately read even lines and odd lines of a photographing device at different points of time to obtain corresponding even line data and odd line data; and a data processor configured to perform motion estimation on one of the even line data and the odd line data on the basis of an image related to the other of the even line data and the odd line data of an immediately prior point of time to the one of the even line data and the odd line data, to generate a motion-compensated image.

The interval at which the one of the even line data of the odd line data is read may be equal to or greater than twice a reference interval, and the interval at which the odd line data and the even line data are read may be equal to or greater than the reference interval and smaller than the interval at which the one of the even line and the odd line data is read. The interval at which the odd line data and the even line data are read may correspond to half of the interval at which the one of the even line data and the odd line data is read.

When the motion-compensated image is generated, motion estimation may be additionally performed on one of the even line data and the odd line data on the basis of an image corresponding to one of an even line data or an odd line that that is of an immediately prior point of time to the other of the even line data and the odd line data, and on the basis of a result of the motion estimation.

The image related to the one of the even line data and the odd line data may correspond to a first image corresponding to the other of the even line data and the odd line data or a second image generated by performing motion compensation on the other of the even line data and the odd line data. When the motion estimation is performed based on the second image, the one of the even line data and the odd line data may be interpolated in a vertical direction.

An image processing apparatus having a reference mode and a low luminance mode includes a photographing device configured to be controlled during the low luminance mode to have a shutter speed corresponding to a first field interval and a second field interval that occurs subsequent to and overlaps with the first field interval, and to output a first field image data corresponding to a first set of pixels during the first field interval and a second field image data corresponding to a second set of pixels during the second field interval; a digital signal processor configured to store the first field image data and the second field image data in respective memories thereof, and to generate a frame image from the first field image data and the second field image data by estimating and compensating motion components of the second field image data relative to the first field image data; a luminance detector configured to determine whether a detected brightness does not exceed a predetermined reference value; and a controller configured to set the low luminance mode based on the determination by the luminance detector, and to control the shutter speed of the photographing device during the low luminance mode.

Accordingly, a quantity of electric charges charged in the photographing device comes to be increased such that a bright image of an object can be taken and a motion of an image comes to be accurately estimated such that a more distinct moving image can be obtained.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a configuration of a camera to which the present invention is applied;

FIG. 2 is a block diagram of parts of the camera to which the present invention is applied;

FIG. 3 illustrates a method for processing images in a camera according to an embodiment of the present invention; and

FIG. 4 illustrates a method for processing images in a camera according to another embodiment of the present invention.

### DETAILED DESCRIPTION OF THE PREFERRED EMBODIMENTS

Hereinafter, a method and an apparatus for processing images in a camera according to embodiments of the present invention will be described below with reference to the accompanying drawings.

The method and apparatus for processing images in a camera according to embodiments of the present invention can be applied to cameras of various types that can capture moving images, such as a monitoring camera including a CCD or CMOS photographing device.

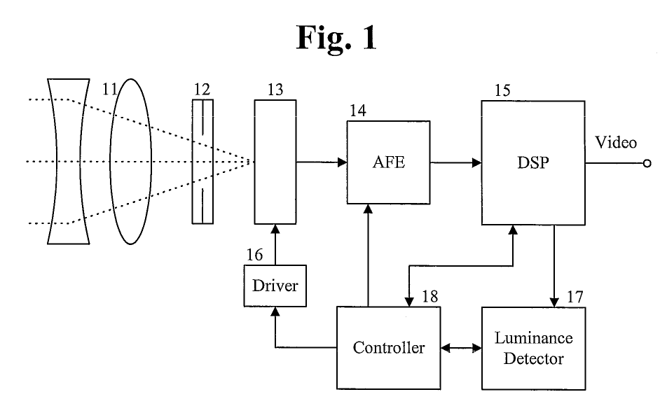

FIG. 1 illustrates a configuration of a camera to which the present invention is applied. The camera may include a lens unit 11, an iris 12, a photographing device 13, an analog front end 14, a digital signal processor 15, a photographing device driver 16, a luminance detector 17, and a controller 18.

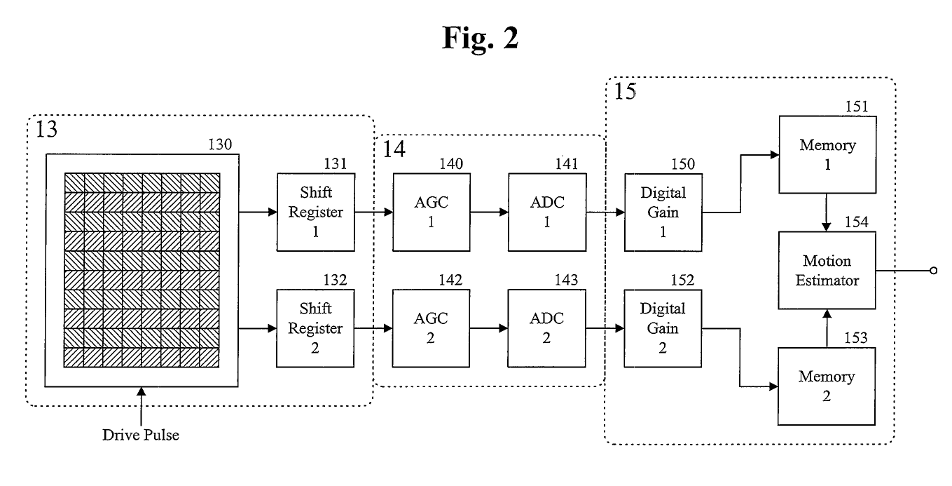

As shown in FIG. 2, the photographing device 13 may include a first shift register 131 for reading electric charges charged in odd-numbered line pixels and a second shift register 132 for reading electric charges charged in even-numbered line pixels.

The analog front end 14 may include a first automatic gain controller 140 for amplifying an analog signal output from the first shift register 131 to a predetermined level, a first analog-to-digital converter 141 for converting the amplified analog signal into a digital signal, a second automatic gain controller 142 for amplifying an analog signal output from the second shift register 132 to a predetermined level, and a second analog-to-digital converter 143 for converting the amplified analog signal into a digital signal.

The digital signal processor 15 may include a first digital gain controller 150 for controlling the gain of the digital signal output from the first analog-to-digital converter 141 and amplifying the digital signal, a first memory 151 for temporarily storing the amplified digital signal, a second digital gain controller 152 for controlling the gain of the digital signal output from the second analog-to-digital converter 143 and amplifying the digital signal, and a second memory 153 for temporarily storing the amplified digital signal.

Furthermore, the digital signal processor 15 may include a motion estimator 154 for estimating and compensating motion components between images corresponding to the digital signals stored in the first and second memories 151 and 153.

The luminance detector 17 analyzes image data processed by the digital signal processor 15 to detect whether or not the camera is in a low-illumination photographing state. For instance, the luminance detector 17 determines that the camera is in the low-illumination photographing state that requires a shutter speed of the photographing device 13 to be controlled if an average brightness of a photographed image of an object does not exceed a predetermined reference value even when the iris 12 is opened wide and an analog gain is increased.

The controller 18 sets a low-illumination photographing mode according to a detection signal output from the luminance detector 17. The luminance detector 17 may be configured in a software form in the digital signal processor 15 or the controller 18.

When the low-illumination photographing mode is set, the controller 18 may control the photographing device driver 16 to adjust the shutter speed of the photographing device 13, that is, to change a period in which electric charges are charged in each pixel line of the photographing device 13 and an electric signal corresponding to the charged electric charges is output from one field corresponding to a reference mode to at least two fields.

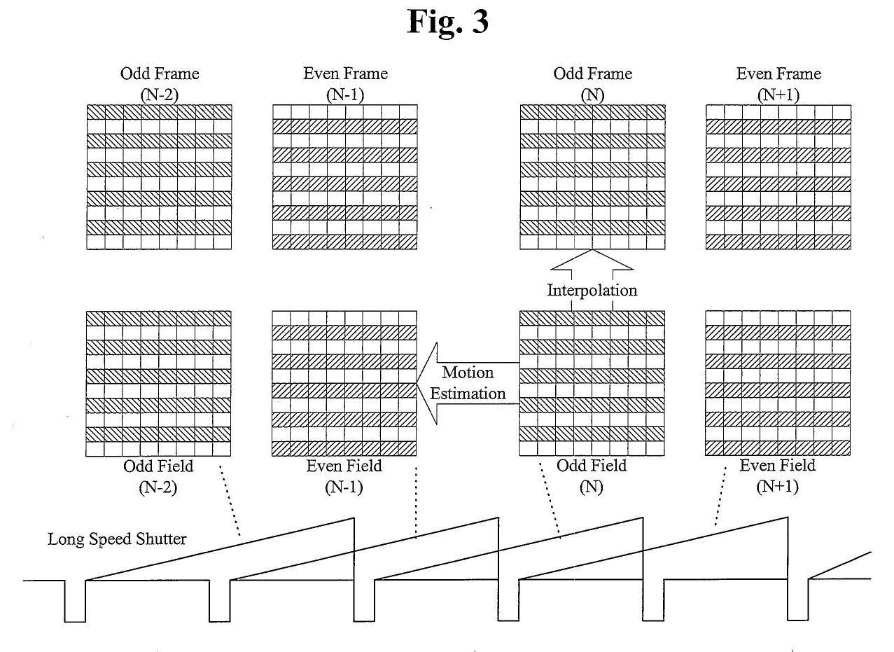

For instance, when the shutter speed is controlled to change the period in which the electric signal is output to a two-field period, as illustrated in FIG. 3, odd-numbered line pixels and even-numbered line pixels of the photographing device 13 may be separately read at different points of time. For instance, odd-numbered field data and even-numbered field data may be respectively read in a one-field interval interlaced manner.

Odd-numbered field image data of the odd-numbered line pixels, read in the one-field interval interlaced manner, passes through the first shift register 131, the first automatic gain controller 140, the first analog-to-digital converter 141, and the first digital gain controller 150 and is temporarily stored in the first memory 151 and even-numbered field image data of the even-numbered line pixels, read in the one-field interval interlaced manner, passes through the second shift register 132, the second automatic gain controller 142, the second analog-to-digital converter 143, and the second digital gain controller 152 and is temporarily stored in the second memory 153, as described above with reference to FIG. 2.

The digital signal processor 15 may estimate and compensate motion components of an object based on the image data temporarily stored in the first memory 150 and the second memory 152 through the motion estimator 154, compose a motion-compensated image and output the motion-compensated image or predict a difference between previous and current images through motion estimation and compensation and compress the predicted image difference.

When the digital signal processor 15 generates a frame image corresponding to an odd field image at a time N, the digital signal processor 15 may perform motion estimation and motion compensation based on an even field image at a previous time N-1 or a frame image generated from the even field image.

When a motion of an odd or even field image at the time N is estimated from a frame image generated at the previous time N-1, vertical interpolation is performed on the odd or even field image such that the odd or even field image becomes the same size as that of the frame image because the odd or even field image is obtained by omitting even-numbered lines or odd-numbered lines from a frame image.

Furthermore, when the digital signal processor 15 generates the frame image corresponding to the odd field image at the time N, the digital signal processor 15 may perform motion estimation and motion compensation based on not only the even field image at the previous time N-1 (or the even frame image generated based on the even field image) but also an odd field image at a previous time N-2 (or an odd frame image generated based on the odd field image) to obtain more accurate motion estimation and compensation result. Theoretically, a motion vector estimated from the image at the time N-1 has a size corresponding to half of the size of a motion vector estimated from the image at the time N-2.

Accordingly, the odd field image and the even field image have high luminance because they are generated from electric charges charged for two frames. Furthermore, motions of the odd field image and even field image are estimated from the image one field prior, and thus the motions can be estimated and predicted more accurately as compared to a conventional method of performing motion estimation from at least two frames in order to increase luminance.

Meanwhile, even though the shutter speed is set to a two-field period in the low-illumination photographing mode, the controller 18 may vary a timing clock pulse signal applied to the photographing device 13 according to the detection signal of the luminance detector 17 to control the time length of a field period or a field interval to cope with low luminance. When a reference field period is 1/60 seconds, for instance, the controller 18 may determine the timing clock pulse signal applied to the photographing device 13 through the photographing device driver 16 to set the shutter speed, that is, an interval of generating an odd field image or an even field image, to 1/30, 1/20 or 1/15 seconds.

The controller 18 may set the shutter speed to a period corresponding to four fields or more according to the detection signal of the luminance detector 17 and read an odd field image and an even field image in an interlaced manner at a period corresponding to half of the shutter speed in the low-illumination photographing mode. For instance, when the shutter speed is set to a four-field period, the controller 18 can detect the odd field image and the even field image at a period of four fields. Here, the controller 18 may detect the odd field image and the even field image at an interval of two fields.

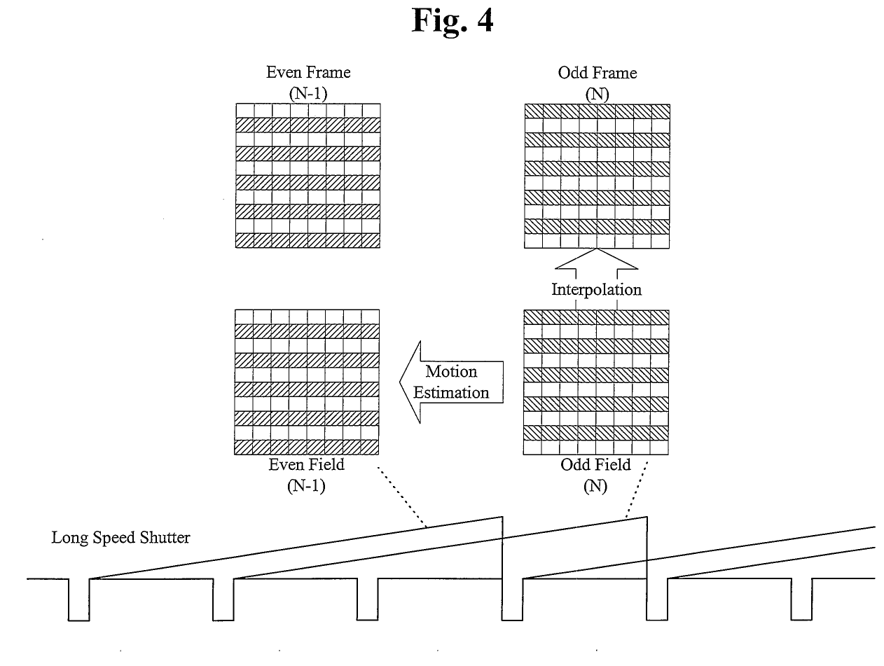

Furthermore, the controller 18 may control interval of the time point of detecting the odd field image and that of detecting the even field image to be different from half of a set shutter speed within the value of the shutter speed. For instance, when the controller 18 detects the odd field image and the even field image at a period of three fields, as illustrated in FIG. 4, the controller 18 can detect the odd field image and the even field image at an interval equal or greater than one field corresponding to the reference field interval and smaller than three fields, for example, at an interval of one field or two fields.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image processing method in a camera, the method comprising:
respectively reading even lines and odd lines of a photographing device of the camera at different points of time to obtain corresponding even line data and odd line data thereof; and
performing motion estimation on one of the even line data and the odd line data on the basis of an image related to the other of the even line data and the odd line data of an immediately prior point of time to the one of the even line data and the odd line data, to generate a motion-compensated image.

2. The image processing method of claim 1, wherein an interval at which the one of the even line data and the odd line data is read is equal to or greater than twice a reference interval.

3. The image processing method of claim 2, wherein an interval at which the odd line data and the even line data are read is equal to or greater than the reference interval and smaller than the interval at which the one of the even line data and the odd line data is read.

4. The image processing method of claim 2, wherein the interval at which the odd line data and the even line data are read corresponds to half of the interval at which the one of the even line data and the odd line data is read.

5. The image processing method of claim 1, wherein performing of the motion estimation comprises additionally performing another motion estimation on the one of the even line data and the odd line data on the basis of an image corresponding to one of an even line data and an odd line data that is of an immediately prior point in time to the other of the even line data and the odd line data, and on the basis of a result of the motion estimation.

6. The image processing method of claim 1, wherein the image related to the other of the even line data and the odd line data includes a first image corresponding to the other of the even line data and the odd line data, and a second image generated by performing motion compensation on the other of the even line data and the odd line data.

7. The image processing method of claim 6, wherein the performing of the motion estimation interpolates the one of the even line data and the odd line data in a vertical direction when the motion estimation is performed based on the second image.

8. An image processing apparatus in a camera, comprising:
an image data reading unit configured to separately read even lines and odd lines of a photographing device of the camera at different points of time to obtain corresponding even line data and odd line data; and
a data processor configured to perform motion estimation on one of the even line data and the odd data line on the basis of an image related to the other of the even line data and the odd data line of an immediately prior point of time to the one of the even line data and the odd data line, to generate a motion-compensated image.

9. The image processing apparatus of claim 8, wherein the image data reading unit is configured to control an interval at which the one of the even line data and the odd line data is read to be equal to or greater than twice a reference interval.

10. The image processing apparatus of claim 9, wherein the image data reading unit is configured to control an interval at which the odd line data and the even line data are read to be equal to or greater than the reference interval and smaller than the interval at which the one of the even line data and the odd line data is read.

11. The image processing apparatus of claim 9, wherein the image data reading unit is configured to control the interval at which the odd line data and the even line data are read to correspond to half of the interval at which the one of the even line data and the odd line data is read.

12. The image processing apparatus of claim 8, wherein the data processor is configured to additionally perform another motion estimation on the one of the even line data and the odd line data on the basis of an image corresponding to one of an even line data and an odd line data that is of an immediately prior point in time to the other of the even line data and the odd line data, and on the basis of a result of the motion estimation.

13. The image processing apparatus of claim 8, wherein the image related to the other of the even line data and the odd line data includes a first image corresponding to the other of the even line data and the odd line data, and a second image generated by performing motion compensation on the other of the even line data and the odd line data.

14. The image processing apparatus of claim 13, wherein the data processor is configured to interpolate the one of the even line data and the odd line data in a vertical direction when performing the motion estimation based on the second image.

15. An image processing apparatus having a reference mode and a low luminance mode, the apparatus comprising:
a photographing device configured to be controlled during the low luminance mode to have a shutter speed corresponding to a first field interval and a second field interval that occurs subsequent to and overlaps with the first field interval, and to output a first field image data corresponding to a first set of pixels during the first field interval and a second field image data corresponding to a second set of pixels during the second field interval;
a digital signal processor configured to store the first field image data and the second field image data in respective memories thereof, and to generate a frame image from the first field image data and the second field image data by estimating and compensating motion components of the second field image data relative to the first field image data;
a luminance detector configured to determine whether a detected brightness does not exceed a predetermined reference value; and
a controller configured to set the low luminance mode based on the determination by the luminance detector, and to control the shutter speed of the photographing device during the low luminance mode.

16. The image processing apparatus of claim 15, wherein the first field interval and the second field interval are an integer multiple of a reference interval of the normal mode.

17. The image processing apparatus of claim 15, wherein the first field image data is one of an even field image data and an odd field image data, and the second field image data is the other of the even field image data and the odd field image data.

18. The image processing apparatus of claim 15, wherein the digital signal processor is configured to additionally generate the frame image from the first field image data and the second field image data by interpolating the second field image data relative to the first field image data.

19. The image processing apparatus of claim 15, wherein the first field interval and the second field interval are interlaced so that they are spaced over a reference interval of the normal mode.

20. The image processing apparatus of claim 15, wherein the image processing apparatus is a digital camera.
